(19) United States
(12) Patent Application Publication
(10) Pub. No.: US 2011/0305105 A1
(43) Pub. Date: Dec. 15, 2011

(54) CONTROLLING SEISMIC SOURCES IN CONNECTION WITH A SEISMIC SURVEY

(76) Inventor: Timothy James Dean, Redhill (GB)

(21) Appl. No.: 12/796,714

(22) Filed: Jun. 9, 2010

(51) Int. Cl. G01V 1/00

(52) U.S. Cl. 367/14

(57) ABSTRACT

A technique includes receiving requests from mobile seismic sources and organizing the requests in a queue. The seismic sources are associated with respective paths of a survey plan, and each request indicates that one of the seismic sources is ready for an action to be performed by the seismic source. The technique includes regulating an ordering associated with the requests based on survey parameters and responding to the requests according to the ordering.

### BACKGROUND

The invention generally relates to controlling seismic sources in connection with a seismic survey.

Seismic exploration involves surveying subterranean geological formations for hydrocarbon and mineral deposits. A survey typically involves deploying seismic source(s) and seismic sensors at predetermined locations. The sources generate seismic waves, which propagate into the geological formations creating pressure changes and vibrations along their way. Changes in the elastic properties of the geological formation scatter the seismic waves, changing their direction of propagation and other properties. Part of the energy emitted by the sources reaches the seismic sensors. Some seismic sensors are sensitive to pressure changes (hydrophones) and others are sensitive to particle motion (e.g., geophones). Industrial surveys may deploy only one type of sensors or both. In response to the detected seismic events, the sensors generate electrical signals to produce seismic data. Analysis of the seismic data can then indicate the presence or absence of probable locations of hydrocarbon or mineral deposits.

One type of seismic source is an impulsive energy source, such as dynamite for land surveys or a marine air gun for marine surveys. The impulsive energy source produces a relatively large amount of energy that is injected into the earth in a relatively short period of time. Accordingly, the resulting data generally has a relatively high signal-to-noise ratio, which facilitates subsequent data processing operations. The use of an impulsive energy source for land surveys may pose certain safety and environmental concerns.

Another type of seismic source is a seismic vibrator, which is used in connection with a “vibroseis” survey. For a seismic survey that is conducted on dry land, the seismic vibrator imparts a seismic source signal into the earth, which has a relatively lower energy level than the signal that is generated by an impulsive energy source. However, the energy that is produced by the seismic vibrator's signal is transmitted over a relatively longer period of time.

### SUMMARY

In an embodiment of the invention, a technique includes receiving requests from mobile seismic sources and organizing the requests in a queue. The seismic sources are associated with respective paths of a survey plan, and each request indicates that one of the seismic sources is ready for an action to be performed by the seismic source. The technique includes regulating an ordering associated with the requests based on survey parameters and responding to the requests according to the ordering.

In another embodiment of the invention, an article includes a computer readable storage medium that stores instructions that when executed by a computer cause the computer to receive requests from mobile seismic sources and form them into a queue. The seismic sources are associated with respective paths of a survey plan, and each request indicates that one of the seismic sources is ready for an action to be performed by the seismic source. The instructions when executed by the computer cause the computer to regulate an ordering associated with the requests based on survey parameters and respond to the requests according to the ordering.

In yet another embodiment of the invention, a system includes a queue and a controller that is coupled to the queue. The queue receives requests to join from mobile seismic sources. The seismic sources are associated with respective paths of a survey plan, and each request indicates that one of the seismic sources is ready for an action to be performed by the seismic source. The controller regulates an ordering associated with the requests based on survey parameters and responds to the requests according to the ordering.

Advantages and other features of the invention will become apparent from the following drawing, description and claims.

### BRIEF DESCRIPTION OF THE DRAWING

FIG. 1 is a schematic diagram of a vibroseis acquisition system according to an embodiment of the invention.

FIG. 2 is a schematic diagram of a seismic acquisition system according to an embodiment of the invention.

FIGS. 3 and 4 illustrate queue discipline according to embodiments of the invention.

FIG. 5 is a flow diagram depicting a technique to regulate responding to requests made by mobile seismic sources according to an embodiment of the invention.

FIG. 6 is a flow diagram depicting a technique to regulate an ordering of pending requests according to an embodiment of the invention.

FIG. 7 is a flow diagram depicting a technique for activating mobile seismic sources according to an embodiment of the invention.

FIGS. 8, 9, 10 and 11 are illustrations depicting exemplary movement of mobile seismic sources when one of the sources falls behind schedule with respect to the other seismic sources.

FIGS. 12, 13, 14 and 15 are illustrations depicting movement of seismic sources in a staggered arrangement according to embodiments of the invention.

FIG. 16 is a flow diagram depicting a technique to regulate responses to requests made by mobile seismic sources and activate the mobile seismic sources according to an embodiment of the invention.

### DETAILED DESCRIPTION

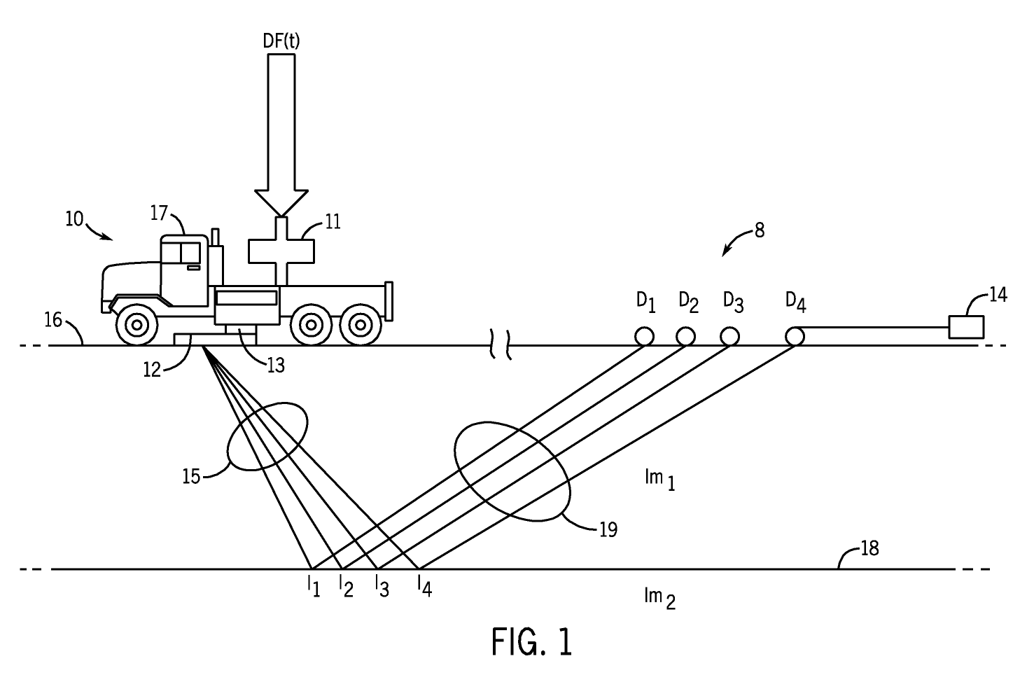

A land-based vibroseis acquisition system in accordance with embodiments of the invention may include mobile seismic sources, such as a surface-located seismic vibrator 10, which is depicted in FIG. 1. As described below, the vibrator 10 may be one of a fleet of mobile seismic sources which, in turn is one of a number of fleets, or groups, which move along respective source lines for purposes of conducting a geophysical seismic survey. For purposes of simplicity, a single vibrator 10 is depicted in FIG. 1. In addition to the vibrator 10, the acquisition system includes surface-located geophones D₁, D₂, D₃ and D₄; and a data acquisition system 14.

To perform the survey, the mobile seismic sources, such as the seismic vibrator 10 each generate a seismic source signal 15. An interface 18 between subsurface impedances Im₁ and Im₂ reflects the signal 15 at points I₁, I₂, I₃ and I₄ to produce a reflected signal 19 that is detected by the geophones D₁, D₂, D₃ and D₄; respectively. The data acquisition system 14 gathers the raw seismic data acquired by the geophones D₁, D₂, D₃ and D₄, and the raw seismic data may be processed to yield information about subsurface reflectors and the physical properties of subsurface formations.

For purposes of generating the seismic source signal 15, the seismic vibrator 10 contains an hydraulic actuator that drives a vibrating element 11 in response to a driving signal (called “DF(t)”). More specifically, the driving signal DF(t) may be a sinusoid whose amplitude and frequency are changed during the sweep. Because the vibrating element 11 is coupled to a base plate 12 that is in contact with the earth surface 16, the energy from the element 11 is coupled to the earth to produce the seismic source signal 15.

It is noted that in accordance with other embodiments of the invention, the vibrating element 11 may be driven by an actuator other than a hydraulic actuator. For example, in accordance with other embodiments of the invention, the vibrating element 11 may be driven by an electro-magnetic actuator. Additionally, in accordance with other embodiments of the invention, the seismic vibrator 10 may be located in a borehole and thus, may not be located at the surface. In accordance with some embodiments of the invention, seismic sensors, such as geophones, may alternatively be located in a borehole. Therefore, although specific examples of surface-located seismic vibrators and seismic sensors are set forth herein, it is understood that the seismic sensors, the seismic vibrator or both of these entities may be located downhole depending on the particular embodiments of invention. Thus, many variations are contemplated and are within the scope of the appended claims.

Among its other features, the seismic vibrator 10 may include a signal measuring apparatus 13, which includes sensors (accelerometers, for example) to measure the seismic source signal 15 (i.e., to measure the output force of the seismic vibrator 10). As depicted in FIG. 1, the seismic vibrator 10 is mounted on a truck 17, an arrangement that enhances the vibrator's mobility.

The vibrating element 11 contains a reaction mass that oscillates at a frequency and amplitude that is controlled by the driving signal DF(t): the frequency of the driving signal DF(t) sets the frequency of oscillation of the reaction mass; and the amplitude of the oscillation, in general, is controlled by a magnitude of the driving signal DF(t). During the sweep, the frequency of the driving signal DF(t) transitions (and thus, the oscillation frequency of the reaction mass transitions) over a continuous range of frequencies. The amplitude of the driving signal DF(t) may also vary during the sweep pursuant to a designed amplitude-time envelope.

As noted above, the seismic vibrator 10 is one of a number of mobile seismic sources that may be used in a particular seismic survey. In this manner, a typical land-based seismic survey includes multiple source lines and receiver points. The seismic sources, such as seismic vibrators, typically are used to acquire seismic data at source points along the lines. In a typical configuration, groups of seismic vibrator(s) may be disposed along respective source lines such that the seismic vibrators emit seismic energy at different source points along their respective source lines.

Acquisition in modern seismic acquisition systems typically is “source driven,” as the seismic source typically sends a “ready tone” (herein called a “request”) to the acquisition system to alert the acquisition system that the source is ready to generate seismic energy at that point. The acquisition system typically processes these requests in the order in which the requests are received; and a given seismic source does not generate seismic energy until the corresponding request is granted by the seismic acquisition system. If there are sufficient seismic sources available, then a virtual queue is formed, which contains the pending requests.

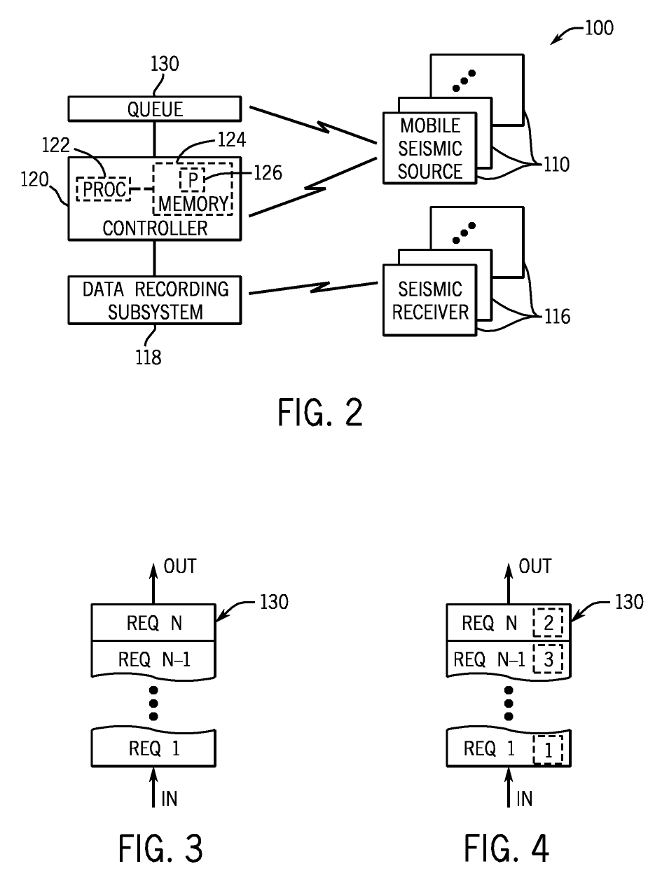

Referring to FIG. 2, a seismic acquisition system 100 in accordance with embodiments of the invention described herein includes mobile seismic sources 110 and seismic receivers 116. It is noted that FIG. 2 is a schematic representation of the seismic acquisition system 100; and the actual spatial locations of the seismic sources 110 and seismic receivers 116 are not represented in FIG. 2.

In accordance with embodiments of the invention, the seismic acquisition system 100 includes a controller 120, which receives ready tones, herein called “requests,” from the seismic sources 110. Each request indicates when a particular seismic source 110 is ready to be activated. As a non-limiting example, the activation of a seismic source 110 means the transmission of a signal from the controller 120 to the source 110 granting the source 110 permission to emit seismic energy. The activation of a given seismic source 110 may involve a subset of these acts, in accordance with other implementations. However, regardless of the particular implementation, the request that is communicated by a given seismic source 110 indicates that the source 110 is ready to take an action in the seismic survey; and the seismic source 110 awaits for authorization from the controller 120 (in response to the request) before taking that action.

It is noted that a number of factors may control whether a particular seismic source 110 is on or behind schedule. In this regard, each mobile seismic source 110 experiences a move-up time between source points, which is the time for the source 110 to move from one point to the next. Although the source points may be uniformly spaced apart, small obstructions may cause the move-up times to significantly vary, and as a result, not all of the seismic sources 110 may remain on schedule. Obstructions that have significant linear extent, such as roads, although likely to have similar effects on the overall distribution of move-up times for all sources, may not affect them at the same time during the day unless the obstacles are oriented perpendicularly to the source lines. The vibrator(s) may also suffer mechanical failure delaying their movements. If the energy is not successfully transmitted then the vibrator will need to sweep again without moving up.

If move-up times do vary significantly between the seismic sources 110, then the relative production rates are different as well as the positions of the sources 110. As a result, the seismic sources 110 do not necessarily move in unison along their respective source lines. As a result, at any given time, some of the seismic sources 110 may be behind schedule.

Typically, the order in which seismic sources are triggered is the order in which the ready tones, or requests, are received. However, in accordance with embodiments of the invention described herein, the controller 120 responds to the requests from the mobile seismic sources 110 in an order that is determined based at least in part on whether some of the seismic sources 110 are behind schedule. In this manner, the controller 120 effectively assigns higher priorities to mobile seismic sources 110 that are behind schedule; and as a result, pending requests from these lagging mobile seismic sources 110 are granted before the other pending requests. Due to this control, the seismic sources 110 adhere to the survey plan.

There are many advantages to be gained from managing the relative positions of seismic sources in such a manner during a survey. As non-limiting examples, such advantages include minimizing the time that the seismic sources 110 spend in hazardous or inconvenient locations; maintaining the seismic sources 110 in close proximity to each other, which allows mechanics to respond quickly to the seismic sources 110 when repairs are required; reducing the distances that the seismic sources 110 need to move when repairs are needed; reducing the times for moving the seismic sources 110 between source lines (as explained further below in a survey plan in which the seismic sources 110 are intentionally spatially staggered); and reducing the time that each receiver line is required, which means the receivers may be moved as quickly as possible to thereby decrease the chance that a lack of receivers slows down the acquisition of the survey.

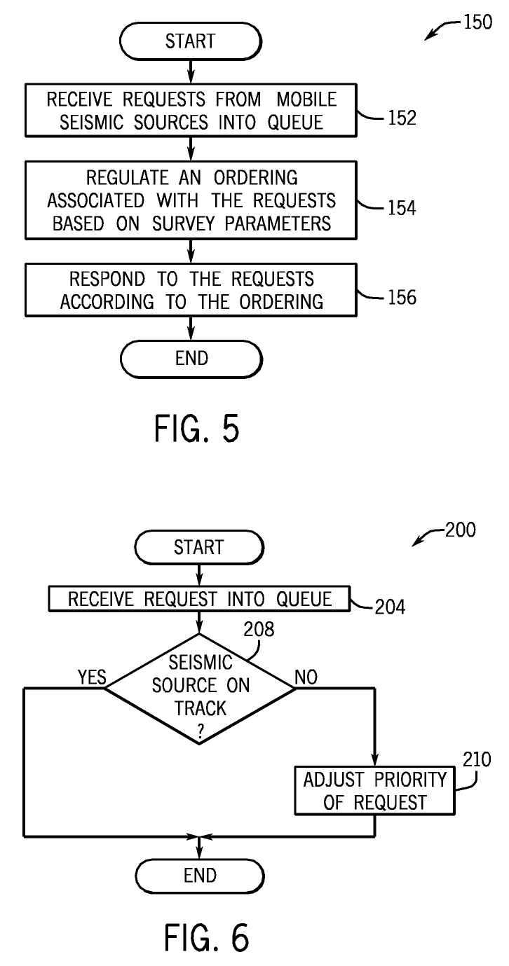

Referring to FIG. 5 in conjunction with FIG. 2 in accordance with some embodiments of the invention, the seismic acquisition system 100 (FIG. 2) performs a technique 150 that is depicted in FIG. 5. Pursuant to the technique 150, the seismic acquisition system 100 receives (block 152) pending requests from the mobile seismic sources 110 and forms them into a queue. The seismic sources 110 are associated with respective paths of the survey plan, and each request indicates that one of the seismic sources 110 is ready for action to be performed by the seismic source (e.g., the request indicates that the corresponding source 110 is ready to emit seismic energy at the point). The seismic acquisition system 110 regulates (block 154) an ordering associated with the requests as the requests are being received based on survey parameters and responds to the requests according to the ordering, pursuant to block 156.

As a specific example, the survey parameters may be parameters that indicate whether the seismic sources are behind a schedule along their respective paths. However, other variations are contemplated and are within the scope of the appended claims. For example, in accordance with other embodiments of the invention, the parameters may be parameters that are indicative of source group priorities. For example, assigning priorities to individual groups may be particularly useful, as it enables the groups in areas with limited access (military bases, for example) to finish quickly by assigning them relatively higher priorities. Furthermore, it permits groups that may be “struggling” (groups that are running short of fuel, groups that are in danger of breaking down, etc.) during the survey to be used little as possible without negatively impacting productivity by assigning them low priorities. The ordering in the queue may be based on other survey parameters, in accordance with other embodiments of the invention.

Referring to FIG. 2, turning now to the more specific details, in accordance with some embodiments of the invention, the requests from the mobile seismic sources 110 are received in a queue 130, which may be a physical or virtual queue. In accordance with some embodiments of the invention, the queue 130 is, by default, a first in first out (FIFO) queue, which is illustrated in more detail in FIG. 3. Referring to FIG. 3 in conjunction with FIG. 2, the controller 120, in general, processes pending requests stored in the queue 130 in the order in which the requests are received. Thus, referring to FIG. 3, pursuant to the FIFO policy, request REQ_{N} in FIG. 3 is the first received request in the queue 130 for this example, and REQ₁ is the last received request in the queue 130. Therefore, pursuant to the default FIFO ordering, the controller 120 processes the request REQ_{N} as the next request, processes the request REQ_{N-1} request, etc.

Some of the mobile seismic sources 110 may be behind schedule, however, and as a result, the controller 120 circumvents the FIFO ordering. In accordance with some embodiments of the invention, the controller 120 may rearrange the positions or memory locations of the requests in the queue 130 to accomplish this, and in accordance with other embodiments of the invention, the controller 120 assigns priorities to the requests, which may change as the requests are being processed. For the example depicted in FIG. 4, a higher priority request is associated with a higher priority number. For example, the request REQ₁ is associated with priority “1,”, which means that the controller 120 processes the request REQ₁ before other requests having a higher associated priority number. The next request processed is REQ_{N} (having a priority of “2” for this example). As shown, request REQ_{N-1} has a priority of “3,” which means that it is the next request processed. It is noted that for some scenarios, some of the requests may have the same priority. For these cases, the controller 120 may, for example, process pending requests at the same priority in the order in which the requests are received into the queue 130. Other and different arrangements are contemplated in accordance with other embodiments of the invention.

Referring back to FIG. 2, among the potential implementation details, in accordance with some embodiments of the invention, the queue 130 may reside in a memory that is part of or separate from the controller 120, depending on the particular implementation. The controller 120, in general, may include one or more microprocessors and/or microcontrollers and, in general, includes a processor 122, which executes program instructions 126 that are stored in a memory 124. As depicted in FIG. 2, this memory 124 may be a memory of the controller 120, although the program instructions 126 may be stored in another memory, in accordance with other embodiments of the invention.

Among its other features, the seismic acquisition system 100 may include a data recording subsystem 118 that is connected to receive seismic measurements from the seismic receivers 116. It is noted that depending on the particular implementation, the mobile seismic sources 110 may communicate wirelessly with the controller 120 and queue 130; and in accordance with some embodiments of the invention, the seismic receivers 116 may also communicate wirelessly with the data recording subsystem 118 or may communicate with the subsystem 118 via a hardwire connection. Thus, many variations are contemplated and are within the scope of the appended claims.

Referring to FIG. 6, in accordance with some embodiments of the invention, the controller 120 processes the pending requests, which are received from the mobile seismic sources 110 according to a technique 200. Pursuant to the technique 200, the controller 120 receives a request (block 204) from the seismic sources 110 into the queue 130 and makes a determination (diamond 208) whether the corresponding seismic source 110 is on track. If so, then the controller 120 does not adjust the corresponding priority of the request and instead allows the request to be processed based on its received order. Otherwise, if the corresponding seismic source 110 is behind schedule along its path, then the controller 120 adjusts (block 210) the priority of the request.

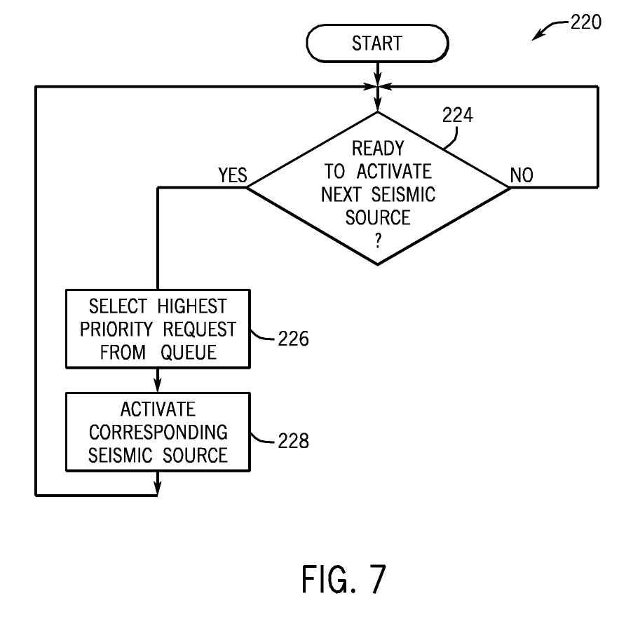

Referring to FIG. 7, in accordance with some embodiments of the invention, the controller 120 performs a technique 220 for purposes of processing the requests and communicating the corresponding activation signals to the mobile seismic sources 110. Pursuant to the technique 220, the controller 120 determines (diamond 224) whether the seismic receivers 116 are ready for the next activation of a seismic source 110. If so, then the controller 120 selects the highest priority request from the queue, pursuant to block 226. It is noted that if several requests have the same priority, which is the current highest priority, then the controller 120 may select the request in the order that the request was received into the queue 130. Next, the controller 120 activates the corresponding seismic source (e.g., sends a signal to the source indicating approval for the source to transmit energy), pursuant to block 228. As an example, the controller 120 may communicate an activation signal to the selected seismic source. Other variations are contemplated and are within the scope of the appended claims.

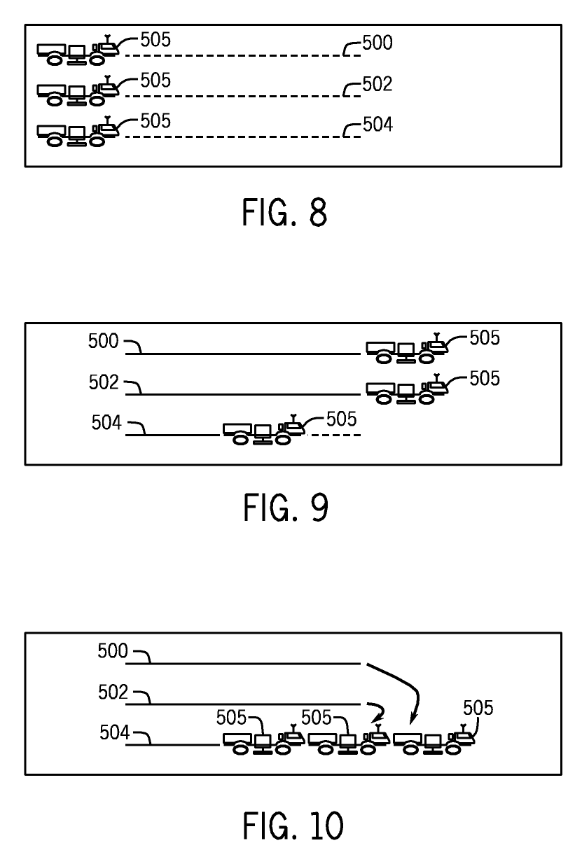

FIG. 8 depicts an example in which three seismic sources 505 are located on three parallel source lines 500, 502 and 504, respectively. In general, FIGS. 8, 9, 10 and 11 are illustrations of a scenario in which a particular mobile seismic source 505 falls behind schedule with respect to other seismic sources 505. For this example, the other mobile seismic sources are used to take over source points for the seismic source 505 that falls behind. However, this technique is relatively inefficient, as described below.

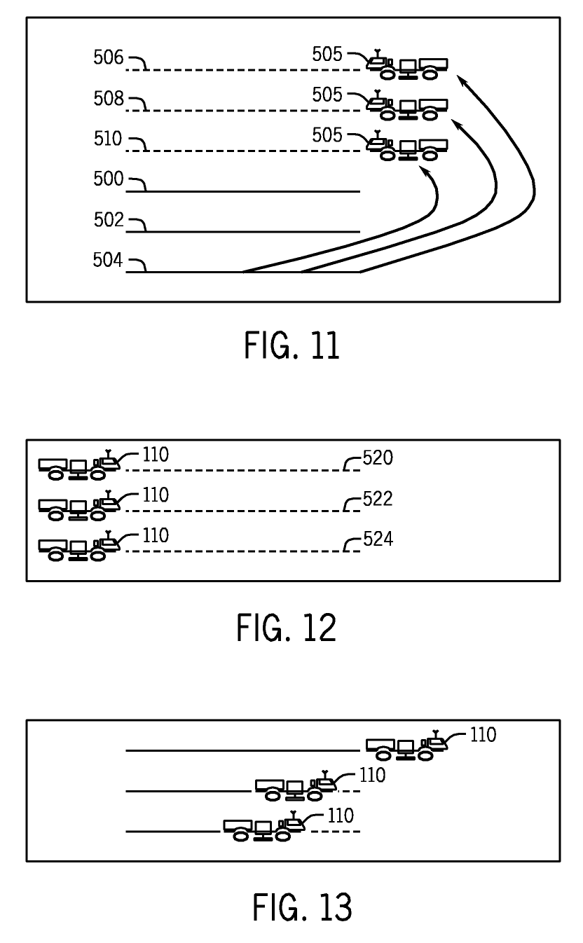

For this example, the seismic source 505 on the source line 504 encounters some obstructions which causes the seismic source 505 to fall behind the other seismic sources 505, as illustrated in FIG. 9. If the pending requests queue discipline scheme that is disclosed herein is not used, then the seismic sources 505 on the other two source lines 500 and 502 may be moved to the source line 504 to help the lagging seismic source 505 complete its source line 504, as depicted in FIG. 10. After the completion of all of the source points on source line 504, all three seismic sources 505 are then moved to new respective source lines 506, 508 and 510, as depicted in FIG. 11. In terms of the distance traveled in terms of line spacing, for the above-described scenario, the seismic source 505 that corresponds to source line 500 travels seven spacings; the seismic source 505 corresponding to seismic source line 502 travels five spacings; and the seismic source 505 that corresponds to source line 504 travels three spacings. Thus, a total of fifteen spacings are traveled for this example. However, with the priority-based queue discipline technique described herein, the seismic sources would only have moved nine spaces if all three seismic sources 505 completed their sources lines at the same time. If a line spacing of 200 meters is assumed, this represents a minimum extra move-up of 1,200 meters. Using typical move-up times and assuming a communication overhead of three minutes, the total time loss is more than seven minutes for each source line change. Over twenty four hours of production, this may add up to nearly an hour of lost time.

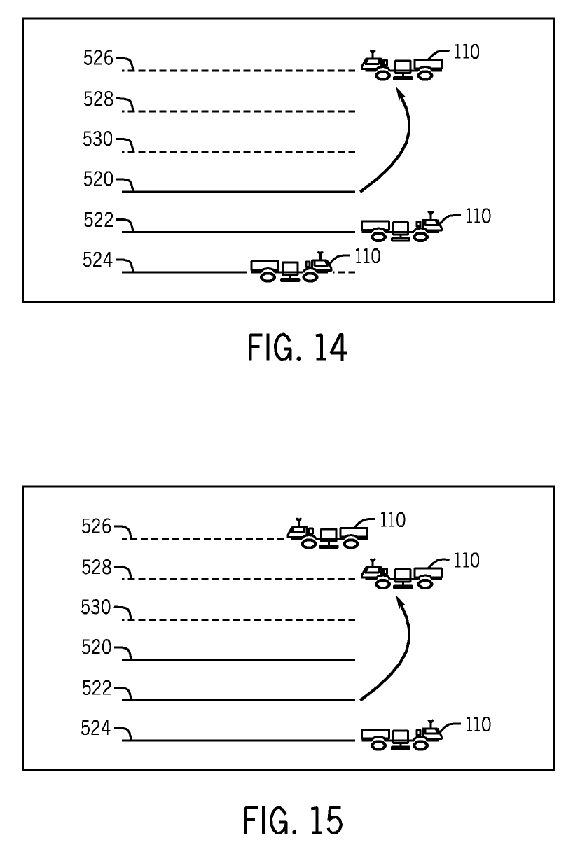

FIGS. 12, 13, 14 and 15 depict an alternative scenario in which the priority-based queue discipline technique that is disclosed herein is used and the seismic sources 110 are intentionally staggered along respective source lines 520, 522 and 524. For this example, the seismic sources 110 start at the same time on the parallel source lines 520, 522 and 524, as depicted in FIG. 12. The priorities are regulated to force the seismic sources 110 to become and then remain staggered along the source lines, as depicted in FIG. 13. Referring to FIG. 14, due to this staggering, when one seismic source 110 moves to its next source line (such as seismic source 110 moving from source line 520 to new source line 526), the other seismic sources 110 continue shooting along their respective source lines 522 and 524. Referring to FIG. 15, thus, when the seismic source on seismic source 522 moves to the seismic source line 528, the seismic sources along source lines 524 and 526 continue shooting. Likewise, when the seismic source on source line 524 moves to seismic source line 530, the seismic sources 110 on source lines 526 and 528 continue shooting along these source lines. Having only one seismic source moving at any time maximizes productivity.

The priority-based queue discipline technique that is employed herein ensures that the staggering is preserved, regardless of whether any particular seismic source 110 encounters more obstructions than the other sources 110.

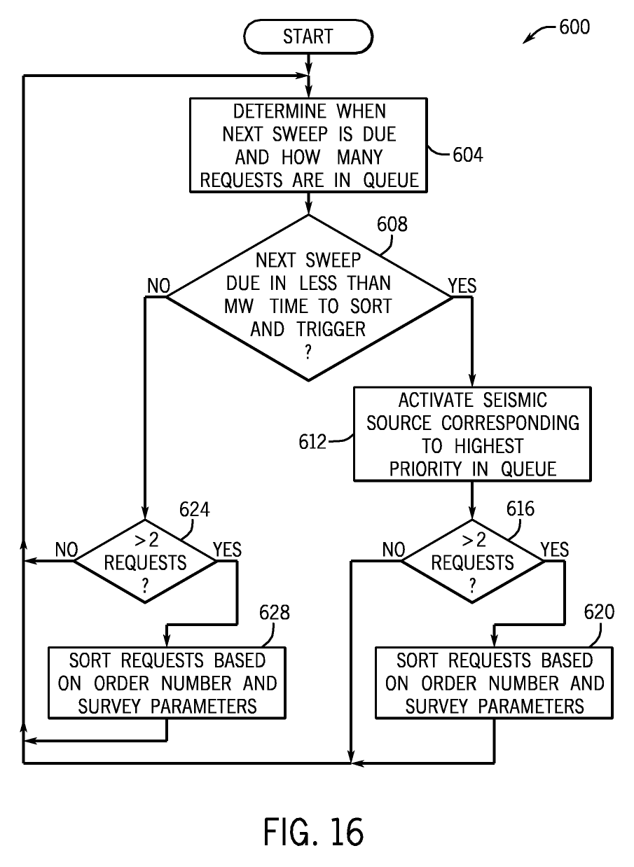

Other embodiments are contemplated and are within the scope of the appended claims. For example, in accordance with some embodiments of the invention, the controller 120 may perform a technique 600 that is depicted in FIG. 16 for purposes of regulating the ordering of the requests in the queue as well as activating the seismic sources. Pursuant to the technique 600, the controller 120 determines (block 604) when the next sweep is due and how many requests are in the queue. If the next sweep is due in less than the minimum time required to resort the queue and/or activate a sweep, as determined in diamond 608, then the controller 120 proceeds to activate (block 612) the seismic source that corresponds to the highest priority request in the queue. The controller 120 then sorts (block 620) the requests in the queue based on order numbers associated with the requests and the survey parameters, as described above, if there are more than two requests in the queue (a decision made in diamond 616). If the next sweep is not due less than a minimum time between sweeps (diamond 608), then the controller 120 sorts (block 628) the requests based on order number and survey parameters if there are more than two requests in the queue (as decided in diamond 624).

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
receiving requests from mobile seismic sources and organizing the requests in a queue, the seismic sources being associated with respective paths of a survey plan and each request indicating that one of the seismic sources is ready for an action to be performed by the seismic source;
regulating an ordering associated with the requests as the requests are being received based on survey parameters; and
responding to the requests according to the ordering.

2. The method of claim 1, wherein the regulating comprises basing the regulation in part on a determination of whether at least one of the seismic sources is behind schedule for advancing along the respective path.

3. The method of claim 1, wherein the survey parameters comprise:
parameters indicative of whether the seismic sources are experiencing difficulties during the survey.

4. The method of claim 1, wherein the survey parameters comprise:
parameters indicative of source group priorities.

5. The method of claim 1, wherein the act of receiving comprises
organizing the requests in a queue that defines the order based on ordered positions of the requests in the queue; and
controlling the positions based at least in part on the determination.

6. The method of claim 5, wherein the act of responding comprises:
assigning the positions by default according to an order defined by a first in first out policy and changing the assigned default positions in response to determining that at least one of the seismic sources is behind the schedule.

7. The method of claim 5, wherein the act of responding to the request comprises:
assigning default priorities to the requests based on when the requests are received; and
selectively changing the default priorities based at least in part of the determination.

8. The method of claim 1, wherein the act of responding regulates movement of the seismic sources according to the survey plan.

9. The method of claim 1, wherein the mobile seismic sources comprise seismic vibrators.

10. The method of claim 1, wherein the mobile seismic sources are associated with varying moveup times along their respective paths and the act of responding comprises responding more timely to requests from a seismic source associated with longer moveup times than a seismic source associated with relatively shorter moveup times.

11. The method of claim 1, wherein the paths comprise source lines.

12. The method of claim 11, further comprising:
staggering the seismic sources along the source lines; and
performing the responding to cause only one of the seismic sources at a time to switch source line during a seismic survey.

13. An article comprising a computer readable storage medium storing instructions that when executed by a computer cause the computer to:
receive requests from mobile seismic sources and organize the requests in a queue, the seismic sources being associated with respective paths of a survey plan and each request indicating that one of the seismic sources is ready for an action to be performed by the seismic source;
regulate an ordering associated with the requests as the requests are being received based on survey parameters; and
respond to the requests according to the ordering.

14. The article of claim 13, the storage medium storing instructions that when executed cause the computer to base the regulation in part on a determination of whether at least one of the seismic sources is behind schedule for advancing along the respective path.

15. The article of claim 13, wherein the survey parameters comprise:
parameters indicative of whether the seismic sources are experiencing difficulties during the survey.

16. The article of claim 13, wherein the survey parameters comprise:
parameters indicative of source group priorities.

17. The article of claim 13, the storage medium storing instructions that when executed cause the computer to:
initially assign the ordering according to first in first out policy and change the initially assigned priorities in response to determining that at least one of the seismic sources is behind an associated schedule for advancing along the respective path.

18. The article of claim 17, wherein the mobile seismic sources are associated with varying moveup times along their respective paths, the storage medium storing instructions that when executed cause the computer to respond more timely to requests from a seismic source associated with longer moveup times than a seismic source associated with relatively shorter moveup times.

19. A system comprising:
a queue to receive requests from mobile seismic sources, the seismic sources being associated with respective paths of a survey plan and each request indicating that one of the seismic sources is ready for an action to be performed by the seismic source; and
a controller coupled to the queue to:
receive requests from mobile seismic sources and organize the requests in a queue based on survey parameters, and
respond to the queue based on the ordering.

20. The system of claim 19, wherein the survey parameters indicate whether at least one of the seismic sources is behind schedule for advancing along the respective path.

21. The system of claim 19, wherein the survey parameters comprise:
parameters indicative of whether the seismic sources are experiencing difficulties in the survey.

22. The system of claim 19, wherein the survey parameters comprise:
parameters indicative of source group priorities.

23. The system of claim 19, wherein
the queue is adapted to organize the requests according to a first in first out policy; and
the controller is adapted to override the first in first out policy in response to the survey parameters.

24. The system of claim 23, wherein the controller is adapted to selectively change priorities of the requests received in the queue based at least in part on the survey parameters.

25. The system of claim 19, further comprising:
the seismic sources.

26. The system of claim 25, further comprising:
seismic receivers to receive seismic energy produced by the seismic sources.

27. The system of claim 19, wherein the paths comprise source lines.

28. The system of claim 19, wherein the controller is adapted to:
stagger the seismic sources along the source lines; and
regulate the responding to cause only one of the seismic sources at a time to switch to another source line during a seismic survey.
